(19) United States
(12) Patent Application Publication
(10) Pub. No.: US 2024/0100974 A1
(43) Pub. Date: Mar. 28, 2024

(54) ELECTRIC VEHICLE PROVIDED WITH AN ADAPTER FOR CHARGING AN ELECTRIC BATTERY

(71) Applicant: RENAULT S.A.S., Boulogne Billancourt (FR)

(72) Inventors: Mayeul BONNET, GUYANCOURT CEDEX (FR); Thierry HODIESNE, GUYANCOURT (FR); Philippe LABREVOIS, GUYANCOURT (FR)

(73) Assignee: RENAULT S.A.S., Boulogne Billancourt (FR)

(21) Appl. No.: 18/264,133

(22) PCT Filed: Jan. 28, 2022
(86) PCT No.: PCT/EP2022/052143

§ 371 Date: Aug. 3, 2023

(30) Foreign Application Priority Data
Feb. 4, 2021 (FR) FR2101065

(51) Int. Cl. B60L 53/16; B60L 53/35

(52) U.S. Cl. CPC B60L 53/16; B60L 53/35

(57) ABSTRACT

A vehicle includes an electric battery and an electric socket for supplying electricity to the battery. The socket is positioned in a bodywork element defining the vehicle so as to be accessible from outside the vehicle. The socket includes a guide for routing a tip of a power supply gun opposite the socket such that the head can penetrate into a receiving area of the socket in order to ensure that the battery is electrically charged.

The present invention relates to an electric vehicle provided with an adapter for charging an electric battery.

Currently, a person wishing to charge the electric battery of their vehicle grasps an electrical power nozzle provided with an end piece, then inserts this end piece into the electrical socket of their vehicle. Since this supply nozzle is connected to an external electrical source, this person charges the electric battery of their vehicle by keeping the end piece in the socket until the electric battery is charged. They then remove the nozzle, and the vehicle can leave with a charged electric battery. In order to alleviate any ambiguity, such a method for charging the electric battery is effected without having to move the battery in the vehicle or remove it from said vehicle. The end piece is represented by an electrical connector.

In such an individual context, the person can afford to take some time, by performing successive trial-and-error experiments, in order to adjust the position of the end piece of the electrical supply nozzle, before introducing said end piece into the socket of their vehicle.

However, in the event of automatic charging of the electric battery of a vehicle by means of a robot, the above-mentioned trial-and-error experiments when a person is handling the electrical supply nozzle are no longer possible. It then becomes difficult to systematically correctly position the end piece of the nozzle with respect to the socket of the vehicle, rendering uncertain the charging of the electric battery in the vehicle.

A vehicle according to the invention has an electrical socket for an electric battery of said vehicle, said socket being configured to allow the end piece of the electrical supply nozzle to always be placed in a satisfactory position facing said socket, in order to systematically ensure the charging of the battery.

A subject of the invention is a vehicle comprising an electric battery and an electrical socket intended to supply electricity to said battery, said socket being placed in a bodywork element, delimiting said vehicle, so as to be accessible from the outside of said vehicle.

According to the invention, the socket comprises guide means intended to route an end piece of an electrical supply nozzle to the correct position facing said socket, such that said end piece can systematically penetrate into a receiving area of said socket in order to ensure electrical charging of the battery. Preferably, the receiving area comprises a plurality of parallel channels intended to be occupied by tubular and rectilinear rods of the end piece of the supply nozzle, in order to ensure the charging of the battery. In this way, if the end piece of the supply nozzle were positioned so as to be slightly eccentric with respect to the receiving area of the socket, it would suffice to push said end piece toward said socket, such that the guide elements can orient the direction of movement of said end piece toward the receiving area of the socket. By pushing the end piece toward the socket, it initially comes into abutment against the guide elements and then slides along said guide means so as to be placed directly facing the receiving area. These guide means are placed around the receiving area, and are preferably constituted by hollows and/or bosses placed on said socket. Advantageously, these guide means are constituted by protruding elements such as planar walls whose orientation allows them to route the end piece of the supply nozzle toward the receiving area of the socket. The term “systematically” should be interpreted as “each time”. The end piece is an electrical connector, and the penetration of the end piece into the receiving area makes it possible to ensure electrical contact between said end piece and said receiving area.

According to one possible feature of the invention, the guide means are constituted by a wall forming a funnel, said wall delimiting a flared end opening and a reduced end opening placed around the receiving area of the socket, said flared end opening being placed further toward the outside of the vehicle than the reduced end opening is.

In this way, the end piece of the supply nozzle will firstly meet the flared end area, then, by pushing the end piece toward the socket, said end piece will be directed toward the reduced end opening in the wall, said reduced end opening closely surrounding the receiving area of the socket. Once the end piece is correctly positioned facing the receiving area, it suffices to cause the end piece of the supply nozzle to slide into the receiving area in order to ensure the charging of the battery.

According to one possible feature of the invention, the portion of the wall delimiting the reduced end opening surrounds the receiving area so as to leave no space with respect to said receiving area. In this way, the end piece will always be ideally placed in front of the receiving area before being pressed therein, without the risk of being slightly eccentric with respect to said receiving area.

According to one possible feature of the invention, the portion of the wall delimiting the reduced end opening is in contact with a secondary wall delimiting the receiving area. By virtue of this interaction between the portion of the wall forming a funnel and the secondary wall of the socket surrounding the receiving area, the end piece will, systematically and repetitively, always be correctly placed in front of the receiving area.

According to one possible feature of the invention, the wall forming the funnel has inclined faces connecting the flared end opening and the reduced end opening, said inclined faces opening out on two receiving walls that are placed at the same level as the reduced end opening and that cover two magnetized areas of the socket which are placed on either side of the receiving area, said inclined faces being intended to guide the movement of two end magnets of the end piece of the supply nozzle so as to route them toward the two receiving walls. When the end piece of the supply nozzle is brought in front of the socket, it is firstly the two end magnets of said end piece which will come into contact with the wall forming a funnel at the flared end opening. Thus, by pushing this end piece toward the receiving area of the socket, the two magnets of said end piece will slide along the inclined walls before reaching the two receiving walls. When the magnets occupy these receiving walls, the end piece will be ideally placed in front of the receiving area of the socket. The end piece is positioned by way of the two magnets of said end piece. Advantageously, the two receiving walls each form a housing intended to receive a magnet of the end piece. Preferably, the two magnets are each placed at an end of a movable rod of the end piece and therefore have movable positions with respect to the end piece.

According to one possible feature of the invention, the two receiving walls are placed in the same plane, corresponding to a plane in which the reduced end opening is inscribed.

According to one possible feature of the invention, the two receiving walls each have a circular contour for accommodating a magnet of cylindrical form of the end piece of the supply nozzle.

According to one possible feature of the invention, the wall forming a funnel comprises two planar stops that are placed in the flared end opening and that are aligned along a vertical axis, said two stops being intended to block the travel of two movable rods of the end piece of the supply nozzle, springs being wound around said rods.

According to one possible feature of the invention, the wall forming a funnel is an added-on adapter able to be fastened to the electrical socket of the vehicle without modifying the structure of said vehicle. In this way, as a function of the features of the vehicle, it suffices to manufacture an adapter adapted to the vehicle in question, in order to then fasten said adapter to the electrical socket of the vehicle without having to modify the structure of the vehicle in the region of the socket.

A further subject of the invention is a method for charging a battery of a vehicle according to the invention by means of a supply nozzle comprising an end piece surrounded by two first movable rods around which two springs are wound and by two second movable rods each terminating with a magnet.

According to the invention, the method comprises the following steps:
a step of placing the end piece of the supply nozzle in front of the flared end opening in the wall forming a funnel,
a step of pushing said end piece forward toward the receiving area of the socket,
a step of sliding the two magnets of the second rods along the inclined faces connecting the flared end opening and the reduced end opening until said two magnets reach the receiving walls covering two magnetized areas of the socket,
a step of bringing the two first rods into contact against the two stops that are placed at the same level as the flared end opening,
a step of pressing the end piece into the receiving area of the socket, causing a movement of the first rods relative to the end piece, and therefore a compression of the springs,
a step of charging the battery of the vehicle.

A vehicle according to the invention has the advantage of having an electric battery that can be charged satisfactorily and repetitively in each charging operation. It also has the advantage of having an electric battery that can be charged with an electricity supply nozzle controlled by a robot, because even if the nozzle is not ideally placed in front of the electrical socket, the adapter allows said nozzle to be systematically inserted into the receiving area of the electrical socket of the vehicle.

There follows a detailed description of a preferred embodiment of a vehicle according to the invention, with reference to the following figures:

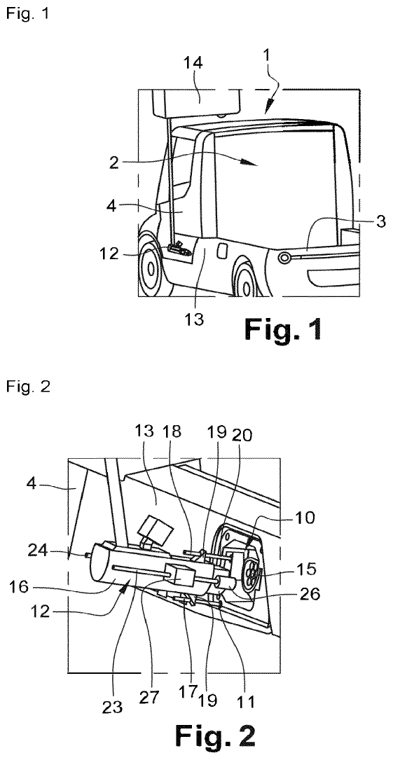

FIG. 1 shows a perspective view of a vehicle according to the invention,

FIG. 2 shows a perspective view of an area showing an electricity supply nozzle and a socket of a vehicle according to the invention, said nozzle being set back from said socket,

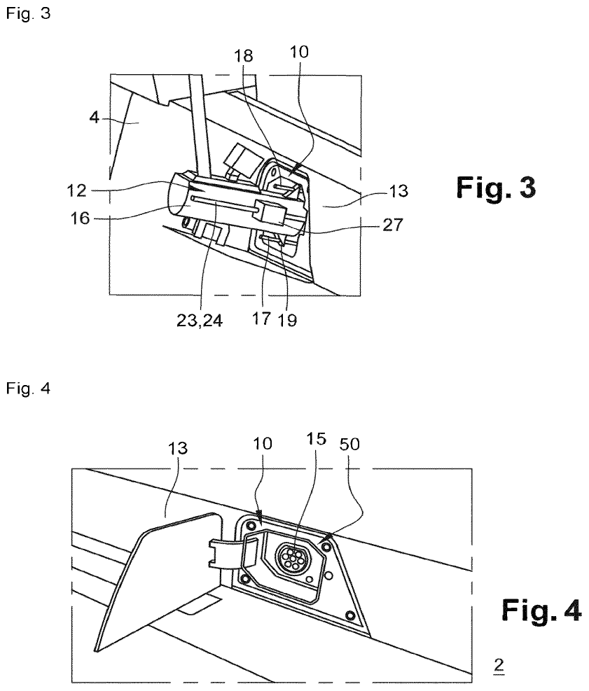

FIG. 3 shows a perspective view of the area in FIG. 2, said nozzle being connected to the socket,

FIG. 4 shows a perspective view of a socket of a vehicle according to the invention,

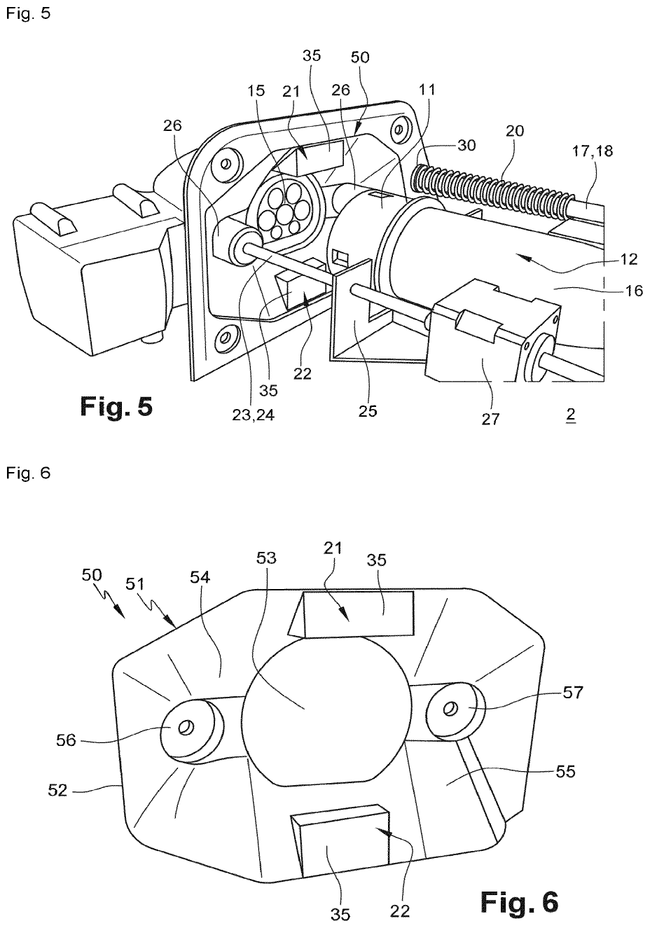

FIG. 5 shows an enlarged perspective view of an electricity supply nozzle and of an electrical socket of a vehicle according to the invention,

FIG. 6 shows a front view of a wall forming a funnel and intended to be fastened to an electrical socket of a vehicle according to the invention,

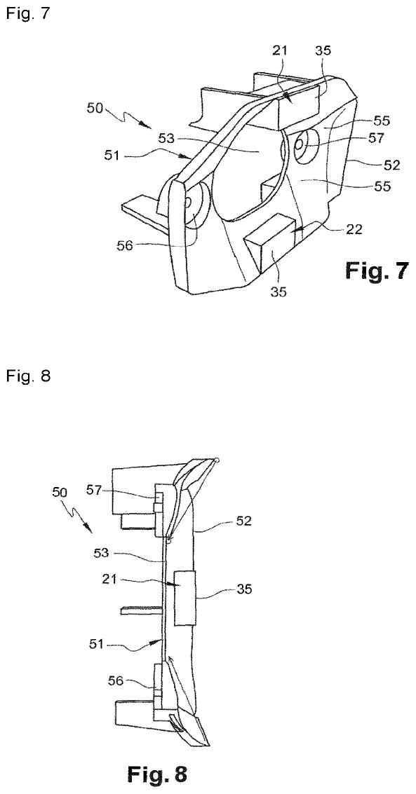

FIG. 7 shows a perspective view of the wall in FIG. 6,

FIG. 8 shows a side view of the component in FIGS. 6 and 7,

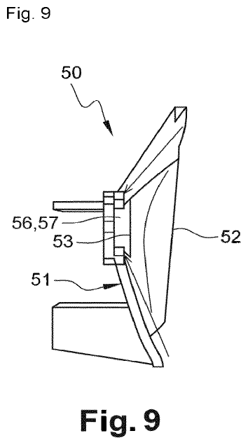

FIG. 9 shows a top view of the component in FIGS. 6, 7 and 8.

Referring to FIG. 1, a vehicle 1 according to the invention is an electric or hybrid vehicle comprising an electric battery and being able to for example be a utility vehicle. The vehicle illustrated in FIG. 1 has a control cabin 2 at the rear of which a loading platform 3 intended to store goods or various objects extends. The control cabin 2 comprises a driver's seat and at least one passenger seat placed next to said driver's seat. A first side door 4 allows access to the driver's seat and a second side door (not visible in the figures) allows access to said at least one passenger seat.

Referring to FIGS. 1, 2, 3 and 4, this vehicle 1 has an electrical socket 10 which is connected to the electric battery of said vehicle 1 and into which an end piece 11 of an electrical supply nozzle 12 is intended to be plugged so as to ensure electrical charging of the battery. This electrical socket 10 is placed in a bodywork element 13 of the vehicle, said bodywork element being situated at the rear of the first side door 4. This electrical socket 10 is flush with an outer surface of this bodywork element 13, so as to be accessible from the outside of said vehicle 1.

Referring to FIGS. 1, 2 and 3, the electrical supply nozzle 12 is electrically connected to an electrical reserve 14 which is external to the vehicle 1.

Referring to FIG. 2, when it is envisioned to electrically charge the electric battery of the vehicle 1, the supply nozzle 12 provided with its end piece 11 is routed so as to face the electrical socket 10 of the vehicle. The end piece 11 acts as an electrical connector intended to be plugged into the electrical socket 10 of the vehicle 1 to establish electrical contact and ensure the charging of the battery.

Referring to FIG. 3, once the supply nozzle 12 is correctly positioned in front of said socket 10, it is then moved in translation along a substantially horizontal axis in such a way that its end piece 11 penetrates into a receiving area 15 of the socket 10. The electric battery of the vehicle 1 can then be charged while remaining in its position within the vehicle.

Referring to FIGS. 2, 3 and 5, the supply nozzle 12 schematically comprises a main body 16, preferably of cylindrical form, extended by the end piece 11 which is itself advantageously of cylindrical form and the diameter of which is substantially equal to that of the main body 16. Two first movable rods 17, 18 extend on either side of the main body 16, by being parallel to a longitudinal axis of said main body 16. These two first rods 17, 18 are therefore disposed around said body 16 by being diametrically opposite. They are each mounted so as to be movable in translation on a first support 19 protruding from the main body 16, and a spiral spring 20 is inserted between said first protruding support 19 and a widened end 30 of the rod 17, 18, said end being intended to come into abutment against a stop 21, 22 of the socket 10. When said ends 30 come into abutment against the stops 21, 22 of the socket, the first rods 17, 18 move relative to the main body 16 along a longitudinal axis of this body 16, by compressing the spring 20. The two first rods 17, 18 are aligned in a vertical plane.

Referring to FIGS. 2, 3 and 5, two second movable rods 23, 24 extend on either side of the main body 16, by being parallel to a longitudinal axis of said main body 16. These two second rods 23, 24 are therefore disposed around said body 16 by being diametrically opposite. These two second rods 23, 24 are aligned in a horizontal plane. They are each mounted so as to be movable in translation on a second support 25 protruding from the main body 16, and each have an end terminating with a magnet 26. These second rods 23, 24 can move along a longitudinal axis of the main body 16 in both directions, by means of a drive 27 borne by each of said second rods 23, 24.

A method for connecting the end piece 11 of the supply nozzle 12 in the receiving area 15 of the electrical socket 10 follows the following steps:
a step of routing the electrical supply nozzle 12 in front of the electrical socket 10 of the vehicle,
a step of bringing the magnets 16 of the second rods 23, 24 into contact with two magnetized zones of the electrical socket 10 of the vehicle 1, by means of the movement of the two second rods 23, 24,
a step of bringing the two first rods 17, 18 into abutment against the stops 21, 22 of the socket 10,
a step of moving the main body 16 of the nozzle 12 toward the electrical socket 10, so as to cause the end piece 11 to penetrate into the receiving area 15 of said socket 10,
a step of moving the two first rods 17, 18 relative to the main body 16 of the supply nozzle 12, resulting in a compression of the two springs 20.

However, when the electrical supply nozzle 12 is controlled by a robot, it is often the case that said nozzle 12 is incorrectly positioned relative to the electrical socket 10, and therefore the connection between the end piece 11 of the nozzle 12 and the receiving area 15 of the electrical socket 10 cannot be effected under proper conditions, preventing the charging of the battery.

In order to prevent any poor positioning of the electrical supply nozzle 12 with respect to the electrical socket 10, a vehicle 1 according to the invention comprises an adapter 50 intended to be fastened to the electrical socket 10 of the vehicle and configured to guide the end piece 11 of the electrical supply nozzle 12 toward the receiving area 15 of said socket 10.

Referring to FIGS. 6 to 9, this adapter 50 comprises a wall 51 forming a funnel, said wall 51 delimiting a flared end opening 52 and a reduced end opening 53, the dimensions of said reduced end opening 53 being smaller than those of the flared end opening 52. This wall 51 forming the funnel has inclined faces 54, 55 connecting the flared end opening 52 and the reduced end opening 53, said inclined faces 54, 55 opening out on two receiving walls 56, 57 that are placed at the same level as the reduced end opening 53. In other words, the reduced end opening 53 is inscribed in a vertical plane, and the two receiving walls 56, 57 are inscribed substantially in the same plane. These two receiving walls 56, 57 each have a circular contour and each delimit a cylindrical housing.

Referring to FIGS. 5, 6 and 7, the wall 51 of the adapter 50 comprises the two stops 21, 22 each having a face 35 that is flush with a vertical plane in which the flared end opening 52 is inscribed.

Referring to FIGS. 5 and 7, the adapter 50 is fastened to the vehicle 1 for example by screwing, so as to cover the electrical socket 10 of said vehicle 1. This adapter 50 is disposed on the vehicle such that:
the two stops 21, 22 are aligned along a vertical axis,
the two receiving walls 56, 57 are aligned along a horizontal axis and cover two magnetized areas of the socket 10,
the reduced end opening 53 is placed around the receiving area 15 of the socket 10 by closely enclosing said receiving area 15, in other words without creating any space with respect to said receiving area 15,
the flared end opening 52 is flush with an outer surface of the bodywork element 13 of the vehicle in which the electrical socket 10 is placed, and the reduced end opening 53 is placed further toward the inside of the vehicle than the flared end opening 52 is.

A method for charging a battery of a vehicle 1 according to the invention comprises the following steps:
a step of placing the end piece 11 of the supply nozzle 12 in front of the flared end opening 52 in the wall 51 forming a funnel,
a step of pushing said end piece 11 forward toward the receiving area 15 of the socket 10 placed in the reduced end opening 53,
a step of sliding the two magnets 26 of the two second rods 23, 24 along the inclined faces 54, 55 connecting the flared end opening 52 and the reduced end opening 53 until said two magnets 26 reach the receiving walls 56, 57 covering the two magnetized areas of the socket 10,
a step of bringing the two first rods 17, 18 into contact against the two faces 35 of the two stops 21, 22 that are flush with the flared end opening 52,
a step of pressing the end piece 11 into the receiving area 15 of the socket 10, causing a movement of the first rods 17, 18 relative to the main body 16 of the electrical supply nozzle 12, and therefore a compression of the springs 20,
a step of charging the battery of the vehicle 1.

The inclined faces 54, 55 of the adapter 50 make it possible to guide the magnets 26 until they reach the receiving faces 56, 57, the guiding of these magnets 26 making it possible to place the charging nozzle 12 in the correct position facing the electrical socket 10 of the vehicle, in such a way that the connecting end piece 11 can be introduced systematically into the receiving area 15 of said socket 10.

1-10. (canceled)

11. A vehicle comprising:
an electric battery and an electrical socket configured to supply electricity to said battery, said socket being placed in a bodywork element, delimiting said vehicle, so as to be accessible from outside of said vehicle,
wherein the socket comprises guide means to route an end piece of an electrical supply nozzle to the correct position facing said socket, such that said end piece can systematically penetrate into a receiving area of said socket to ensure electrical charging of the battery.

12. The vehicle as claimed in claim 11, wherein the guide means include a wall forming a funnel, and said wall delimits a flared end opening and a reduced end opening placed around the receiving area of the socket, said flared end opening being placed further toward the outside of the vehicle than the reduced end opening is.

13. The vehicle as claimed in claim 12, wherein a portion of the wall delimiting the reduced end opening surrounds the receiving area so as to leave no space with respect to said receiving area.

14. The vehicle as claimed in claim 13, wherein the portion of the wall delimiting the reduced end opening is in contact with a secondary wall delimiting the receiving area.

15. The vehicle as claimed in claim 12, wherein the wall forming the funnel has inclined faces connecting the flared end opening and the reduced end opening, and said inclined faces open out on two receiving walls that are placed at the same level as the reduced end opening and that cover two magnetized areas of the socket which are placed on either side of the receiving area, said inclined faces being configured to guide movement of two end magnets of the end piece of the supply nozzle so as to route them toward the two receiving walls.

16. The vehicle as claimed in claim 15, wherein the two receiving walls are placed in the same plane, corresponding to a plane in which the reduced end opening is inscribed.

17. The vehicle as claimed in claim 15, wherein the two receiving walls each have a circular contour for accommodating one of the end magnets of cylindrical form of the end piece of the supply nozzle.

18. The vehicle as claimed in claim 15, wherein the wall forming the funnel comprises two planar stops that are placed in the flared end opening and that are aligned along a vertical axis, and said two stops are configured to block travel of two movable rods of the end piece of the supply nozzle, springs being wound around said rods.

19. The vehicle as claimed in claim 12, wherein the wall forming the funnel is an added-on adapter configured to be fastened to the electrical socket of the vehicle without modifying a structure of said vehicle.

20. A method for charging the battery of the vehicle as claimed in claim 12 by the supply nozzle comprising the end piece surrounded by two first movable rods around which two springs are wound and by two second movable rods each terminating with a magnet, the method comprising:
placing the end piece of the supply nozzle in front of the flared end opening in the wall forming the funnel,
pushing said end piece forward toward the receiving area of the socket,
sliding the two magnets of the second rods along the inclined faces connecting the flared end opening and the reduced end opening until said two magnets reach receiving walls covering two magnetized areas of the socket,
bringing the two first rods into contact against two stops that are placed at the same level as the flared end opening,
pressing the end piece into the receiving area of the socket, causing a movement of the first rods relative to the end piece, and therefore a compression of the springs, and
charging the battery of the vehicle.
